(19) United States
(12) Patent Application Publication
(10) Pub. No.: US 2006/0003274 A1
(43) Pub. Date: Jan. 5, 2006

(54) Antistatic film, method of producing the same, and recording element using the same

(75) Inventors: Naoya Imamura, Shizuoka-ken (JP); Shinji Tanaka, Shizuoka-ken (JP); Akira Hatakeyama, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/173,151

(22) Filed: Jul. 5, 2005

(30) Foreign Application Priority Data
Jul. 5, 2004 (JP) 2004-198573

(51) Int. Cl. G03C 1/85

(52) U.S. Cl. 430/529

(57) ABSTRACT

The invention provides an antistatic film having a support and a conductive layer formed on at least one side of the support, wherein the conductive layer comprises: a reaction product of: a resin containing a plurality of carboxylic acid groups in the molecule and having a weight-average molecular weight of 2,000 or more with a compound having a plurality of carbodiimide structures in the molecule; and a conductive material which exhibits conductivity by electronic conduction. The invention further provides a method of producing the antistatic film and a recording element comprising the antistatic film and a recording layer which is photosensitive or heat-sensitive and is formed on one side of the antistatic film.

### CROSS-REFERENCE TO RELATED APPLICATION

This application claims priority under 35 USC 119 from Japanese Patent Application No. 2004-198573, the disclosure of which is incorporated by reference herein.

### BACKGROUND OF THE INVENTION

1. Field of Invention

The present invention relates to an antistatic film, a method of producing the same, and a recording element using the same, and in particular to an antistatic film useful as a support for recording elements having, for example, a silver salt-based or photopolymer-based photosensitive recording layer or a thermal-transfer or thermal-coloring heat sensitive recording layer, a simple method of producing the same, and a recording element using the antistatic film.

2. Description of the Related Art

Generally, resin films made of a material such as polyethylene terephthalate, polycarbonate, triacetylcellulose, or polypropylene have been used as the supports for photosensitive or heat recording materials. However, being superior in electric insulation properties, these supports were problematic in that they were easily electrified, less easily handled, and readily adsorbed dust present in the environment when used as they are. Accordingly, a conductive layer was often formed on the surface of the resin supports.

These conductive layers generally contain a conductive material and a binder for immobilizing the same as the main components as well as, depending on the application, other components such as wax, organic or inorganic fine particle material, and surfactants, and a crosslinker for crosslinking the binder is often added for the purpose of providing the coated film with a practically sufficient film strength. For example for the purpose of embedding conductive metal oxide particles tightly, a conductive layer containing a hardened product from a polymerizable group-containing resin and a melamine compound has been proposed (see, for example, Japanese Patent Application Laid-Open (JP-A) No. 8-36239). Although effective in embedding a conductive material to some extent, the conductive layer was undesirable from the point of productivity because it was necessary to dry the layer at a high temperature of 150° C. or more or for a long period of 10 minutes or more in order to provide a hardened product sufficient for forming a film having a desirable strength. In a similar way, crosslinkers commonly used such as melamine resins, epoxy resins, and block isocyanate compounds had similar problems and were also problematic in terms of decrease in quality such the deformation, degeneration, and deterioration of a support film caused by drying at high temperature in order to form a desirable crosslinked structure.

Accordingly, for the purpose of obtaining a sufficiently crosslinked product by drying under less severe conditions, use of a highly sensitive crosslinker has also been examined, but highly sensitive crosslinkers, which are thermally instable, raised concerns about deterioration of the storability of the conductive layer-forming coating solution.

Alternatively, an electrification inhibitor composition, which is a combination of a polycarboxyimide crosslinker and a polymerizable monomer, has been proposed for the purpose of improving the storability of the conductive layer-forming coating solution (see, for example, JP-A No. 2001-152077). Although displaying superior stability of the coating solution, the composition was problematic in that the moisture absorption rate of the composition fluctuated according to changes in ambient conditions such as humidity because an ion-conductive quaternary ammonium salt was used as the conductive material, and thus a stabilized antistatic property could not be obtained.

### SUMMARY OF THE INVENTION

The present invention was made in consideration of the above problems. The present invention provides an antistatic film having a high-strength conductive layer formed on a substrate that can be produced at low temperature and in a short period of time. The present invention further provides a method of producing an antistatic film by using a coating solution superior in stability for forming a conductive layer and by forming a conductive layer superior in antistatic property on a support at low temperature and in a short period of time without separation of the conductive material, and a recording element using the antistatic film according to the invention that is easier to use.

After intensive research, the inventors have found that their objectives could be achieved by forming a conductive layer by using an aqueous coating solution containing a compound having a plurality of particular carbodiimide structures and a specific conductive material, and completed the invention.

Namely, the invention provides an antistatic film having a support and a conductive layer formed on at least one side of the support, wherein the conductive layer comprises: a reaction product of: a resin containing a plurality of carboxylic acid groups in the molecule and having a weight-average molecular weight of 2,000 or more with a compound having a plurality of carbodiimide structures in the molecule; and a conductive material which exhibits conductivity by electronic conduction.

The invention further provides a method of producing the antistatic film comprising: preparing an aqueous coating solution; and coating the aqueous coating solution on at least one side of a support, wherein the aqueous coating solution comprises: a resin containing a plurality of carboxylic acid groups in the molecule and having a weight-average molecular weight of 2,000 or more; a compound having a plurality of carbodiimide structures in the molecule; and a conductive material which exhibits conductivity by electronic conduction, and wherein the sum of the solid matter concentration of the resin and the solid matter concentration of the compound is 10 wt % or less.

The invention further provides a recording element comprising the antistatic film and a recording layer which is photosensitive or heat-sensitive and is formed on one side of the antistatic film, wherein the antistatic film has a support and a conductive layer formed on at least one side of the support, and the conductive layer comprises: a reaction product of: a resin containing a plurality of carboxylic acid groups in the molecule and having a weight-average molecular weight of 2,000 or more with a compound having a plurality of carbodiimide structures in the molecule; and a conductive material which exhibits conductivity by electronic conduction.

### DETAILED DESCRIPTION OF THE INVENTION

Hereinafter, the invention will be described in detail.

The antistatic film according to the invention is an antistatic film having a support and a conductive layer formed on at least one side of the support, wherein the conductive layer comprises: a reaction product of: a resin containing a plurality of carboxylic acid groups in the molecule and having a weight-average molecular weight of 2,000 or more with a compound having a plurality of carbodiimide structures in the molecule; and a conductive material which exhibits conductivity by electronic conduction.

The antistatic film according to the invention will be described below, together with the components of the coating solution for forming the conductive layer (conductive layer-forming coating solution) used in production thereof and the method of production.

(I) Reaction Product of (i) Resin Containing Plural carboxylic acid groups in the Molecule and Having a Weight-Average Molecular Weight of 2,000 or More and (ii) Compound Having Plural Carbodiimide Structures in the Molecule.

The (i) “resin containing plural carboxylic acid groups in the molecule and having a weight-average molecular weight of 2,000 or more” (hereinafter, referred to as the “carboxylic acid group-containing resin”) for use in the invention is not particularly limited, as long as it is a resin having a weight-average molecular weight of 2,000 or more to which two or more carboxylic acid groups have been introduced. The carboxylic acid groups may be introduced after preparation of the resin or alternatively during preparation of the resin by copolymerization with a structural unit containing the carboxylic acid groups, but the latter is preferable from the viewpoint of productivity.

Examples of the carboxylic acid group-containing resin include resins which are obtained by co-polymerizing monomers having carboxylic acid(s) such as a polyacrylate, polymethacrylate, polyester, polyurethane, polystyrene, polyacrylonitrile, polyvinylacetate, polyvinylalcohol, styrene-butadiene resin, vinylidene chloride resin, vinylchloride resin, or ethylene-vinylacetate resin.

Preferable examples among these include copolymer resins obtained by co-polymerizing one or more kinds of monomers selected from the group consisting of acrylic acid and methacrylic acid and one or more kinds of monomers having double bond(s) which is capable of being polymerization-reacted. Specific examples of the monomers having the double bond(s) include (meth)acrylates such as a methyl (meth)acrylate, ethyl (meth)acrylate, buthyl (meth)acrylate, octhyl (meth)acrylate, cyclohexyl (meth)acrylate, phenyl (meth)acrylate, or benzyl (meth)acrylate; styrene; divinylbenzene; acrylamide; acrylonitrile; vinylacetate; vinylchloride; vinylidene chloride; ethylene; propylene; butadiene; isoprene; and the like.

Preferable examples of the carboxylic acid group-containing resin further include caroxylic acid group-introduced hydrophilic polymers such as a gelatin, polyvinyl alcohol, cellulose, styrene-maleic acid resin, phenol resin, polyvinyl pyrrolidone and the like.

The carboxylic acid group contained in the carboxylic acid group-containing resin may be introduced therein in a form of an acid group (carboxylic acid group), or may be introduced therein in a form of a neutralized form by bases such as an ammonium, amines, alkali metals, alkali earth metals or the like. A carboxylic acid group which are in a form of a neutralized form is included in the scope of the carboxylic acid group in the invention.

A conductive layer-forming coating solution which contains the resins is preferably prepared as an aqueous coating solution in view of a stability over time. When the conductive layer-forming coating solution is prepared as an aqueous coating solution, the resins may be compounded therein in a form of an emulsion obtained by emulsification polymerization or an emulsion obtained by liquid polymerization of resins, neutralizing the resins with bases, substituting solvents thereof with water, and emulsifying the resins in the water. In a case when the resin itself is a water-soluble polymer, the resin can be used in a form of an aqueous solution.

An aqueous coating solution which contains the resin in a form of an emulsion is preferable in consideration of a viscosity of the coating solution.

A weight average-molecular weight of the carboxylic acid group-containing resin used in the invention is necessarily 2,000 or more in view of a film strength formed thereby. There is no particular upper limitation for the weight average-molecular weight of the carboxylic acid group-containing resin, however, it is preferably 150,000 or less, and is more preferably in a range of 3,000 to 100,000 in views of synthesis adaptivity, which specifically includes molecular weight-controlling and reproductivity.

The carboxylic acid group-containing resin contains plurality of carboxylic acid groups in the molecule thereof. An amount of the introduced carboxylic acid groups per one molecule of the resin can be detected by an acid value. The acid value is preferably in a range of 5 to 400, and more preferably in a range of 10 to 300. The acid value is represented by an amount (mg) of potassium hydroxide required to neutralize 100 g of the resin.

Neutral titration provides an acid value of all acids of the resin including the carboxylic acid group. When a co-polymerization ratio (molar ratio) of the resin is known in advance, an equivalent amount of the carboxylic acid group of the resin can be calculated by using the molar ratio.

There is no particular limitation for a compounds usable as (ii) the compound having plurality of carbodiimide structures in the molecule as long as the compound has plurality of carbodiimide structures in the molecule thereof.

Polycarbodiimides are usually synthesized by a condensation reaction of organic diisocyanates.

As is described above, an aqueous coating solution is preferably used as the conductive layer-forming coating solution in the invention. When the compound having plurality of carbodiimide structures in the molecule is applied by being contained in the aqueous coating solution, it is preferable that hydrophilicity is imparted to the compound by reacting a terminal isocyanate moiety of the compound with a compound which has a functional group having reactivity with isocyanates and a hydrophilic group.

There is no particular limitation for organic compounds usable as organic groups of the organic diisocyanates, and examples thereof include aromatic groups, aliphatic groups, and mixtures thereof. Among these, aliphatic groups are preferable in view of reactivity.

Examples of a raw material of (ii) the compound having plurality of carbodiimide structures in the molecule include organic monoisocyanates, organic diisocyanates, organic triisocyanates and the like.

Examples of the organic isocyanates include aromatic isocyanates, aliphatic isocyanates, and mixtures thereof.

Specific examples of the organic isocyanates include 4,4′-diphenylmethane diisocyanate, 4,4′-diphenyldimethylmethane diisocyanate, 1,4-phenylene diisocyanate, 2,4-trilene diisocyanate, 2,6-trilene diisocyanate, hexamethylene diisocyanate, cyclohexane diisocyanate, xylylene diisocyanate, 2,2,4-trimethylhexamethylene diisocyanate, 4,4′-dicyclohexylmethane diisocyanate, 1,3-phenylene diisocyanate and the like. Further, specific examples of the organic monoisocyanates include isophorone isocyanate, phenyl isocyanate, cyclohexyl isocyanate, buthyl isocyanate, naphthyl isocyanate and the like.

Carbodiimide compounds which can be used in the invention may be available as commercial products such as CARBODILITE® V-02-L2 (manufactured by Nisshinbo Industries,Inc.).

The reaction product (I), which contributes to improving a film strength of the conductive layer of the invention, has a crosslinked structure which is formed by addition reaction of carboxylic acids and carbodiimides. Namely, the reaction product (I) has a structure in which an oxygen atom of a carboxylic acid is added to a carbon atom of a carbodiimide functional group by nucleophilic addition. Such a crosslinked structure can be formed without being heated at a high temperature such as 150° C. or more which may cause a bad effect to a base material of a support of the antistatic film of the invention. Specifically, such a crosslinked structure can be formed by heating it at 30 to 140° C. which is applied during drying the coated layer film, and when the heating is conducted in a short time, the heating temperature is preferably set in a range of 60 to 140° C.

A preferable mixing ratio of (i) the resin containing carboxylic acid groups and (ii) the carbodiimide compound can be calculated based on an acid value of (i) the resin containing carboxylic acid groups and a carbodiimide equivalent amount of (ii) the carbodiimide compound. A molar ratio of carbodiimide groups to carboxylic acid groups (carbodiimide groups:carboxylic acid groups) is preferably in a range of 1:20 to 10:1, more preferably in a range of 1:10 to 5:1, and particularly preferably in a range of 1:5 to 3:1.

It is preferable that the conductive layer-forming coating solution is prepared so that a sum of a solid matter concentration of the resin (i) and a solid matter concentration of the compound (ii) is 10 wt % or less in view of a stability of the coating solution over time. When the sum of the solid matter concentrations is larger than 10 wt %, a probability of collisions of carboxylic acid molecules with carbodiimide molecules since distances between the carboxylic acid molecules and carbodiimide molecules are short, thereby undesirable reactions of the carboxylic acid molecules and carbodiimide molecules tend to easily occur. As a result thereof, a pot life of the coating solution tends to be short, which is not preferable in view of manufacturing suitability. Specific preferable solid matter concentration thereof is in a range of 0.1 to 8 wt %, and more preferable solid matter concentration thereof is in a range of 0.3 to 6 wt %.

A solid matter concentration of the reaction product (I) formed by the resin (i) and the compound (ii) in a formed film (the conductive layer) is preferably in a range of 5 to 90 wt %, more preferably in a range of 10 to 80 wt %, and particularly preferably in a range of 15 to 60wt %.

(II) Conductive Material Which Exhibits Conductivity by Electronic Conduction

The conductive material which exhibits conductivity by electronic conduction for use in the conductive layer-forming coating solution according to the invention (hereinafter, referred to as the “conductive compound”) is not particularly limited, as long as it is a compound exhibiting conductivity by electronic conduction. The reason for the use of a material exhibiting conductivity by electronic conduction as a conductive material in the invention is that when, for example, an ionic compound exhibiting conductivity by ionic conduction such as a quaternary ammonium salt is used as the conductive material, significant fluctuations of the electric conductivity of the conductive layer due to changes in the water absorption rate thereof according to the environment of use are cause for concern, but the conductive material which exhibits conductivity by electronic conduction is less vulnerable to changes in the environment of use and provides a more consistent conductivity.

Examples of the conductive material which exhibits conductivity by electronic conduction include metals and metal oxides which have conductivity, conductive inorganic powders such as carbon black or graphite, and conductive high-molecular compounds described below.

Metal oxide which have conductivity is preferable among these, and specific examples thereof include tin oxide, indium oxide, zinc oxide, titanium oxide, magnesium oxide, aluminum oxide, antimony oxide and the like. Tin oxide and indium oxide are particularly preferable, and tin oxide which is doped by antimony is further preferable for good conductivity and transparency thereof.

Metal powders and conductive inorganic powders such as carbon black or graphite can be also preferably used when transparency is not needed for the antistatic film to which the conductive material is applied.

The primary particle diameter of the metal oxide, metal powder, or inorganic powder is preferably 0.3 μm or less and particularly preferably 0.2 μm or less from the viewpoint of the planarity of the conductive layer. The primary particle diameter is yet more preferably 0.01 to 0.1 μm. When a powder having a greater particle diameter is used, it becomes necessary to thicken the coated film for improvement in planarity; however, a thickened conductive layer does not necessarily provide a higher conductivity simply because it is thicker and, rather, may even cause deterioration in transparency or the like.

Needle-shaped particles as well as spherical particles may be used as the metal oxide or metal powder.

Generally, in the process of coating the conductive layer, metal (oxide) particles cause flaws on rolls or coating defects due to particles separating from the film surface as a result of contact friction with, for example, the conveyer roll, but use of needle-shaped particles allows reduction of the amount of conductivity metal (oxide) added without sacrificing the electrification performance and thus has an advantage of effectively suppressing the separation of particles described above.

When needle-shaped particles are used, the average length of the longer axis of the metal oxides is preferably in a range of 0.01 to 0.5 μm, and is more preferably in a range of 0.02 to 0.4 μm, from the viewpoint of the planarity of the conductive layer. The length is particularly preferably 0.02 to 0.3 μm. Particles having a needle-shaped structure having a ratio of the length of the shorter axis to the length of the longer axis in a range of 3 to 50 are preferable, and those having a ratio in a range of 4 to 40 are particularly preferable. When needle-shaped particles having a ratio of shorter axis length/longer axis length of less than 3 are used, deterioration in conductivity due to decrease of the probability of mutual contact among particles may occur when the particles are coated in the form of a thin film.

Particle shapes of the conductive materials can be confirmed by taking a photograph of the particles at a magnification of 100,000×or more using an electron microscope. Specifically, the aggregation state of particles in the film can be observed by using a transmission electron microscope.

In addition to the metal compounds and inorganic compounds, examples of the conductive material which can be used in the invention further include a conductive high-molecular compound, and preferable examples thereof include a high-molecular compound which has a long conjugated system. Specific examples thereof include polyanilines, polypyrroles, polythiophenes, isothianaphthenylenes and the like, and more specific preferable examples include poly(3,4-ethylenedioxythiophene), polyisonaphtothiophene, and derivatives thereof.

Compounds which are formed by introducing a hydrophilic substituent to the conductive material so as to improve compatibility to an aqueous coating solution are preferable in view of dispersibility, solubility and mixing easiness to an aqueous coating solution. Conductivities of these high-molecular compounds can be largely improved by doping appropriate compounds to the high-molecular compounds. Examples of the compounds which can be doped to the high-molecular compounds include halogens such as I₂, Br₂, Cl, ICl or IBr, Louis acids (for uses in electric chemical dopings) such as ClO₄, AsF₆ or BF₄, protonic acids such as HNO₂, H₂SO₄ or HCl, halogenated transition metals such as FeCl₃ or SnCl₄, alkali metals such as Li, Na or K, and organic compounds such as tetracyanoquinodimethane, tetracyanoethylene or dichlorodicyanoquinone, and the like.

Among these conductive materials, the material particularly preferably used in the invention includes tin oxide having a needle-shaped structure.

The amount of the conductive material added to the conductive layer-forming coating solution is preferably in a range of 10 to 95 wt %, and more preferably in a range of 20 to 90 wt % in terms of solid material.

Other Additives

The conductive layer according to the invention may contain additionally as needed various additives in the range that does not impair the advantageous effects of the invention.

Examples thereof include matting agents and waxes for improvement of the surface properties of conductive layer, in particular friction coefficient.

Examples of the matting agents include organic or inorganic materilas such as a silica, potassium carboxylate, magnesium carboxylate, barium sulfate, polystyrene, polystyrene-divinylbenzene copolymer, polymethyl methacrylate, melamine, benzoguanamine or the like.

Examples of the waxes include a paraffin wax, micro wax, polyethylene wax, polyester wax, carnauba wax, aliphatic acid wax, aliphatic amide, metal soap and the like.

A surfactant may be added to the conductive layer-forming coating solution in view of improving a coatability thereof. There is no particular limitation for the surfactant, and examples thereof include any one of aliphatic surfactants, aromatic surfactants, and fluorine surfactants, nonionic surfactants, anionic surfactants, and cationic surfactants.

Formation of Conductive Layer

The conductive layer according to the invention can be formed by dissolving these materials for forming a conductive layer in a suitable solvent and coating and drying the solution on the substrate described below.

The conductive layer is formed by first preparing an aqueous coating solution containing (i) a resin containing plural carboxylic acid groups in the molecule and having an average molecular weight of 2,000 or more, (ii) a compound having plural carbodiimide structures in the molecule, and (II) a conductive compound exhibiting conductivity by electronic conduction, at a total solid matter concentration of (i) the resin containing plural carboxylic acid groups in the molecule and having an average molecular weight of 2,000 or more and (ii) the compound having plural carbodiimide structures in the molecule of 10 wt % or less, and by then coating and drying the aqueous coating solution on at least one side of a support.

Examples of a solvent used for forming the conductive layer-coating solution include aqueous solvents, which contain water as a main component and further contain water-soluble organic solvents such as lower alcohols such as methanol, ethanol or isopropylalcohol, acetone or methyethyketone, and which can be mixed with water in accordance with necessity.

Organic solvents can also be used as the solvent used for forming the conductive layer of the invention, and examples thereof include lower alcohols such as methanol, ethanol or isopropylalcohol, acetone, methyethyketon, ethyl acetate, propyleneglycol monoacetate, toluene, xylene, petroleum ether and the like.

In view of environment preservation and prevention of explosion, the solvent used for forming the conductive layer-coating solution used in the producing method of the invention is preferably the aqueous solution, and it is more preferable that an amount of organic solvents contained in the aqueous solution is 3% or less, and it is further preferable that the amount of organic solvents contained in the aqueous solution is 1% or less.

Any known coating method can be used for coating the conductive layer-coating solution, and examples thereof include a dip coating, air knife coating, curtain coating, roll coating, wire bar coating, gravure coating, extrusion coating and the like.

It is preferable that drying of the conductive layer after the coating process is conducted at a temperature of 30 to 140° C. for 10 seconds to 15 minutes. The crosslinking structure can be formed by the reaction of the carboxylic acid groups of (i) the carboxylic acid group-containing resin and a carbodiimide structures of (ii) the carbodiimide compound as described above without using generally-used crosslinking agents which perform crosslinking under high temperature conditions. Therefore, the present invention enables to form the conductive layer which has sufficient film strength even by the above-described moderate drying condition which does not affect a support of the antistatic film.

The thickness of the conductive layer according to the invention after coating and drying is not particularly limited and may be defined appropriately according to usage or the kind of the conductive material of the antistatic film; however, the average layer thickness is preferably 3 μm or less and particularly preferably 0.01 to 2 μm for applications that require transparency. When the average thickness of conductive layer is 3 μm or more, there is cause for concern that transparency, coloring, and the like may deteriorate. When the usage does not require transparency, an average thickness of approximately 0.03 to 5 μm is preferable from the viewpoints of film strength and antistatic characteristics.

It is preferable that a protective layer for protecting the conductive layer is further formed on the conductive layer the antistatic film of the invention in accordance with necessity.

The material used for the protective layer is not particularly limited as long as the material can achieve a sufficient adherence with the conductive layer and can form a film. Examples of the material used for the protective layer include a methacrylic resin, acrylic resin, polyester resin, polyurethane resin, styrene-butadiene resin (SBR resin), polyamide resin, cellulose resin, gelatins, polystyrene, polyvinyl chloride, polyvinylidene chloride, silicone resin, fluorine-containing resin, polyethylene resin, polypropylene resin, epoxy resin, styrene-maleic acid resin, phenol resin, ethylene vinylacetate resin, polyvinyl alcohol, phenol resin and the like.

In order to form the protective layer, the resin can be dissolved in an appropriate solvent and coated over the conductive layer. The solvent is appropriately selected in accordance with a characteristics of the resin. Examples of embodiments of the coating of the protective layer include coating the resin by dissolving it in an organic solvent, coating the resin as a dispersant in water, and coating the resin as an aqueous solution.

A surfactant may be added to the protective layer-forming coating solution in order to improve a coatability of the coating solution. The surfactant is not particularly limited, and examples thereof include aliphatic surfactants, aromatic surfactants, and fluorine surfactants. Nonionic surfactants, anionic surfactants, and cationic surfactants can be also used in the invention.

A film thickness of protective layer may be selected in consideration of a characteristics of the resin used, and is generally preferably in a range of 0.01 to 0.5 μm, more preferably in a range of 0.01 to 0.3 μm, and further preferably in a range of 0.02 to 0.2 μm.

When the film thickness of protective layer is too thin, sufficient effect to protect the conductive layer may not be obtained. When the film thickness of protective layer is larger than 0.5 μm, surface resistivity of the protective layer may become high, which deteriorates an antistatic effect which derives from the conductive layer.

Support

A support which is used for the antistatic film of the invention is not particularly limited and is appropriately selected in accordance with usage, and a polyethylene film is generally used therefor.

Examples of the polyethylene film include polyethylene terephthalate, polyethylene naphthalate, polybuthylene terephthalate, polyallylates, polyethersulfone, polycarbonate, polyetherketone, polysulfone, polyphenylene sulfide, polyester liquid crystal polymer, triacetyl cellulose, polypropylene, polyamides, polyimide, polycycloolefins and the like.

Among these, biaxial stretched film of polyethylene terephthalate is particularly preferable in view of elastic modulus and transparency.

For improvement of the adhesion with the conductive layer, the surface of these supports may be subjected as needed to a surface activation treatment such as chemical treatment, mechanical treatment, corona discharge treatment, flame treatment, ultraviolet ray treatment, high frequency wave treatment, glow discharge treatment, active plasma treatment, laser treatment, mixed acid treatment, or ozone/acid treatment. Surface activation, for example, by corona discharge treatment generates polar groups on the support surface and hydrophilizes the surface, improving the wetting efficiency of the aqueous coating solution.

The antistatic film according to the invention can be prepared by coating and drying an aqueous coating solution containing (i) a resin having plural carboxylic acid groups in the molecule and having an average molecular weight of 2,000 or more, (ii) a compound having plural carbodiimide structures in the molecule, and (II) a conductive compound which exhibits conductivity by electronic conduction, in which a total solid matter concentration of (i) the resin having plural carboxylic acid groups in the molecule and having an average molecular weight of 2,000 or more and (ii) the compound having plural carbodiimide structures in the molecule is 10 wt % or less, on the surface of a support subjected to the desired surface treatment as described above and thus forming a conductive layer; and forming a protective layer over the conductive layer surface and a backcoat layer on a surface carrying no conductive layer as desired. The conductive layer may be formed on one face or both faces of the support.

Recording Element

The recording element according to the invention is prepared by forming a photosensitive or heat-sensitive recording layer on the conductive layer side of the antistatic film according to the invention or on the side of the support opposite thereto.

Examples of the photosensitive recording layer include recording layers containing a silver halide photosensitive material or a photopolymerizable photosensitive material; and examples of the thermal recording layer include recording layers containing a melt heat transfer material, sublimation heat transfer material, ablation heat recording material, or thermal coloring recording material. Preferable examples among these include a recording layer comprising an alkali-soluble binder and a polymerizable monomer and is capable of conducting polymerization by light or heat.

Examples of the recording elements having a recording layer of silver halide photosensitive material include black/white or color negative films, positive films, cinema films, roentgen films, lith films, and the like.

Examples of the recording elements having a recording layer of the photopolymerizable photosensitive material containing an alkali-soluble binder, a polymerizable compound, and as needed a photopolymerization initiator and being capable of conducting polymerization by light or heat include photosensitive transfer materials for color filters, photosensitive color-proof transfer materials, photosensitive dry-film resist materials, and the like.

Examples of the recording elements having a recording layer containing a heat recording material include thermal melt transfer films for color printers, sublimation transfer films for color printers, photosensitive laser-recording ablation-transfer film materials, photosensitive thermal color transfer materials, and the like.

When the recording elements of the invention is used as a transfer material as described above, the transfer material may further has a cushion layer and/or an intermediate layer provided between the support and the recording layer. Examples of a constitution of the transfer material include those described in: “Study of an LCD Color Filter Preparation System Using a Colored Photosennsitive Transfer Sheet” IDW95, pp.69-72; “Design of Cushion Layer Which Enables Transfer System to Laminate with High-Speed” IDW98 (1998); and “FUJIFILM RESEARCH & DEVELOPMENT” Vol. 44, pp.25-32(1999).

As described above, the antistatic film according to the invention, which can be prepared easily under a milder heating condition, has superior antistatic characteristics, and thus may be used favorably in various recording elements and has a wide range of applications.

The recording element using the antistatic film according to the invention has superiority in handling property which is provided by its excellent antistatic effect and is effective in suppressing problems due to dust derived from the conductive layer which is provided by its favorable film strength.

### EXAMPLES

The invention is hereinafter specifically explained by using examples, however, the invention is not limited thereby.

### Example 1

A conductive layer-forming coating solution 1, in which a sum of solid concentrations of (i) the carboxylic acid groups-containing resin and (ii) the carbodiimide compound is 12 wt % and which has the following composition, was coated on one surface side of a polyethylene terephtalate film, which had been formed by being biaxial stretched, heated at 240° C. for 10 minutes and subjected to corona discharge treatment and has a thicklness of 75 μm, and dried at 130° C. for 2 minutes so as to form a conductive layer having a thickness of 0.1 μm.

Composition of conductive layer-forming coating solution 1

| | | |
|---|---|---|
| Acrylic resin having plurality carboxylic acid | 30.9 | parts by mass |
| groups (trade name: JURYMER ET-410, | | |
| manufactured by Nihon Junyaku CO., Ltd., | | |
| number average molecular weight: 9,700, | | |
| weight average molecular weight: 17,000, solid | | |
| concentration: 30 wt %) | | |
| Carbodiimide crosslinking agent (trade name: | 6.4 | parts by mass |
| CARBODILITE ® V-02-L2, manufactured by | | |
| Nisshinbo Industries, Inc., solid concentration: | | |
| 40 wt %, carbodiimide equivalent amount: 385) | | |
| Water dispersant of needle-shaped particles of | 131.1 | parts by mass |
| transparent conductive material of tin oxide- | | |
| antimony oxide (trade name: FS-10D, manu- | | |
| factured by Ishihara Sangyo kaisha, Ltd., | | |
| solid concentration: 20 wt %) | | |
| Dispersant of silica microparticles (trade name: | 5.0 | parts by mass |
| SEAHOSTAR ® KE-W30, manufactured by | | |
| Nippon Shokubai Co., Ltd., solid con- | | |
| centration: 20 wt %) | | |
| Surfactant (trade name: NAROACTY HN-100, | 0.73 | parts by mass |
| manufactured by Sanyo Chemical Industries, | | |
| Ltd.) | | |
| Surfactant (trade name: SANDET BL, manu- | 1.44 | parts by mass |
| factured by Sanyo Chemical Industries, Ltd., | | |
| solid concentration: 43 wt %) | | |
| Water | 824.4 | parts by mass |

Next, a conductive layer-forming coating solution 2, which has the following composition, was coated on the conductive layer and dried at 130° C. for 2 minutes so as to form a protective layer having a thickness of 0.05 μm. An antistatic film of Example 1 was thus provided.

Composition of conductive layer-forming coating solution 2

| | | |
|---|---|---|
| Polyethylene latex (trade name: | 17.8 | parts by mass |
| CHEMIPEARL S120, manufactured by Mitsui | | |
| Chamicals, Inc., solid concentration: 27 wt %) | | |
| Colloidal silica (trade name: SNOWTEX ® C, | 11.8 | parts by mass |
| manufactured by Nissan Chemical Industries, | | |
| Ltd., solid concentration: 20 wt %) | | |
| Epoxy curing agent (trade name: DENACOL | 1.7 | parts by mass |
| EX-614B, manufactured by Nagase ChemteX | | |
| Co.) | | |
| Surfactant (trade name: NAROACTY HN-100, | 0.52 | parts by mass |
| manufactured by Sanyo Chemical Industries, | | |
| Ltd.) | | |
| Surfactant (trade name: SANDET BL, manu- | 0.59 | parts by mass |
| factured by Sanyo Chemical Industries, Ltd., | | |
| solid concentration: 43 wt %) | | |

### Example 2

An antistatic film of Example 2 was prepared in the same manner as described in Example 1, except that 30.9 parts by mass of an acryl latex JONCRYL 70 (trade name, manufactured by Johnson Polymer's Corporate, solid concentration: 30 wt %, acid value: 240, weight average molecular weight:16,500) was used instead of the carboxylic acid groups-containing acrylic resin JURYMER ET-410 (described above) and the amount of the carbodiimide compound CARBODILITE® V-02-L2 (described above) was changed to 12.8 parts by mass.

### Example 3

An antistatic film of Example 3 was prepared in the same manner as described in Example 1, except that 23.2 parts by mass of an urethane latex NEOREZ R-967 (trade name, manufactured by Avecia KK, solid concentration: 40 wt %, acid value:19) was used instead of the carboxylic acid groups-containing acrylic resin JURYMER ET-410 (described above) and the amount of the carbodiimide compound CARBODILITE® V-02-L2 (described above) was changed to 3.2 parts by mass.

### Example 4

An antistatic film of Example 4 was prepared in the same manner as described in Example 1, except that 154.1 parts by mass of a water dispersant of spherical particles of conductive material of tin oxide-antimony oxide (trade name: TDL-1, manufactured by Mitsubishi Materials Corporation, solid concentration: 17 wt %) was used instead of the water dispersant of needle-shaped particles of transparent conductive material of tin oxide-antimony oxide FS-10D (described above).

### Example 5

An antistatic film of Example 5 was prepared in the same manner as described in Example 1, except that the protective layer was not provided on the conductive layer thereof.

### Example 6

An antistatic film of Example 6 was prepared in the same manner as described in Example 1, except that a conductive layer-forming coating solution 3, in which a sum of solid concentrations of (i) the carboxylic acid groups-containing resin and (ii) the carbodiimide compound is 12 wt % and which has the following composition, was used instead of the conductive layer-forming coating solution 1, and 10 wt % of the coated amount was reduced.

Composition of conductive layer-forming coating solution 3

| | | |
|---|---|---|
| Acrylic resin having plurality carboxylic acid | 30.9 | parts by mass |
| groups (trade name: JURYMER ET-410, | | |
| manufactured by Nihon Junyaku CO., Ltd., | | |
| number average molecular weight: 9,700, | | |
| weight average molecular weight: 17,000, | | |
| solid concentration: 30 wt %) | | |
| Carbodiimide crosslinking agent (trade name: | 6.4 | parts by mass |
| CARBODILITE ® V-02-L2, manufactured by | | |
| Nisshinbo Industries, Inc., solid concentration: | | |
| 40 wt %, carbodiimide equivalent amount: | | |
| 385) | | |
| Powders of needle-shaped transparent | 13.1 | parts by mass |
| conductive material of tin oxide-antimony | | |
| oxide (trade name: FS-10D, manufactured by | | |
| Ishihara Sangyo kaisha, Ltd., solid | | |
| concentration: 20 wt %) | | |
| Dispersant of silica microparticles (trade name: | 5.0 | parts by mass |
| SEAHOSTAR ® KE-W30, manufactured by | | |
| Nippon Shokubai Co., Ltd., solid | | |
| concentration: 20 wt %) | | |
| Surfactant (trade name: NAROACTY HN-100, | 0.73 | parts by mass |
| manufactured by Sanyo Chemical Industries, | | |
| Ltd.) | | |
| Surfactant (trade name: SANDET BL, manu- | 1.44 | parts by mass |
| factured by Sanyo Chemical Industries, Ltd., | | |
| solid concentration: 43 wt %) | | |
| Water | 33.4 | parts by mass |

### Comparative Example 1

An antistatic film of Comparative example 1 was prepared in the same manner as described in Example 1, except that 2.6 parts by mass of the epoxy curing agent DENACOL EX-614B (described above) was used instead of the carbodiimide crosslinking agent CARBODILITE® V-02-L2 (described above).

Evaluation of Antistatic Film

The surface resistance, scratching strength, and solvent resistance of the antistatic films obtained in Examples 1 to 6 and Comparative Example 1 were determined by the methods below. Results are summarized in Table 1.

(1) Life of Coating Solution

A conductive layer-forming coating solution was left still at 25° C. in air, and the period until the viscosity thereof became twice as high as the initial viscosity was determined. A longer period means a better storability of the coating solution.

(2) Surface Resistance

The surface resistance of an antistatic film was measured in an environment of 22° C. and 65% RH using a surface resistance tester (manufactured by Shinto Scientific Co.). A value 30 minutes after application of voltage was determined under the condition of an electrode distance of 5 mm, an electrode width of 100 mm, and an applied voltage of 50 V.

(3) Scratch Resistance

The surface of a coated layer was rubbed with gauze under a load of 50 g/cm² 100 times, and the scuffs generated thereon were determined by visual examination. The results were grouped into three ranks: no scuff, A; some scuffs, B; and many scuffs, D.

(4) Solvent Resistance

The surface of a coated layer was rubbed with gauze impregnated with acetone under a load of 10 g/cm² ten times, and the scuffs generated thereon were determined by visual examination. A layer with no scratches whatsoever was designated as A, one almost favorable, B; one with a few scratches, C; and one with many scratches, D.

(5) Separation of Conductive Particles (Pulverization)

After storage in an environment of 25° C. and 65% RH for 3 days, a film was processed into a long film having a width of 18 cm.

The long film was conveyed at a line speed of 100 m/min using a handling tester, which is a simulator of photosensitive layer-coating machine, while rotating the drive roll (flat roll) of the tester in the opposite direction at a wrap angle of 180 degrees under the condition of a peripheral speed of 90 m/min for 5 minutes, and then the amount of the powder deposited on the surface of the drive roll surface was evaluated by visual observation as follows:
A: No powdery deposit observed at all
B: Few powdery deposits, and almost favorable
C: Some powdery deposits observable

D: Significant amount of powdery deposits observable

TABLE 1

| | | Surface | | | |
|---|---|---|---|---|---|
| | Life of coating | resistance | Scratch | Solvent | |
| | solution | Log SR (Ω) | resistance | resistance | Pulverization |
| Example 1 | More than 10 days | 8.2 | A | A | A |
| Example 2 | More than 10 days | 8.5 | A | A | A |
| Example 3 | More than 10 days | 8.4 | A | A | A |
| Example 4 | More than 10 days | 9.5 | A | A | B |
| Example 5 | More than 10 days | 8.7 | B | A | B |
| Example 6 | 7 hours | 8.9 | B | A | B |
| Comparative | More than 10 days | 8.3 | D | D | D |
| example 1 | | | | | |

As apparent from the results in Table 1 above, each of the antistatic films according to the invention hardened sufficiently by drying at a temperature lower and in a period shorter than that of Comparative Example 1 using a known crosslinker, had a conductive layer sufficiently higher both in film strength and solvent resistance as well displaying as a sufficiently high strength even when it contained a greater amount of a filler such as an electrification inhibitor. In addition, comparison between the results of Examples 1 and 6 reveals that the conductive layer-forming coating solution produced by the production method according to the present invention using an aqueous coating solution containing a carboxylic acid group-containing resin (i) and a carbodiimide compound (ii) at low concentrations had an improved storability and a longer life. Further, comparison of the results of Example 1 and Examples 4 and 5 demonstrated that use of needle-shaped tin oxide fine particles, a preferable embodiment of the invention, as conductive material or for formation of a protective layer over conductive layer was effective in providing a very high scratch resistance.

In each Example above, the acid value of the carboxylic acid group-containing resin (i) was 45.

### Example 7

Following is an example of a photosensitive transfer material for a color filter which is shown as an embodiment of a recording element which uses the antistatic film of the invention.

A thermoplastic resin layer-forming coating solution H1, which has the following composition, was coated on the antistatic film of Example 1 (the polyethylene terephtalate support having a thickness of 75 μm and having the conductive layer disposed thereon), and dried so as to form a thermoplastic resin layer having a thickness of 0.20 μm.

Composition of thermoplastic resin layer-forming coating solution H1

| | | |
|---|---|---|
| Copolymer of methylmethacrylate/2-ethyl- | 15 | parts by mass |
| hexylacrylate/benzylmethacrylate/methacrylic | | |
| acid (compolyrizing ratio (mol): | | |
| 55/28.8/11.7/4.5, weight average molecular | | |
| weight: 90,000) | | |
| Polypropylene glycol diacrylate (average | 6.5 | parts by mass |
| molecular weight: 822) | | |
| Tetraethylene glycol dimethacrylate | 1.5 | parts by mass |
| p-toluene sulfoneamide | 0.5 | parts by mass |
| Benzophenone | 1.0 | parts by mass |
| Methylethylketone | 30 | parts by mass |

Next, an intermediate layer-forming coating solution B 1, which has the following composition, was coated on the thermoplastic resin layer, and dried so as to form an intermediate layer having a thickness of 1.6 μm.

Composition of intermediate layer-forming coating solution B1

| | | |
|---|---|---|
| Polyvinyl alcohol (trade name: PVA 205, | 130 | parts by mass |
| manufactured by Kuraray Co., Ltd., | | |
| saponification rate: 80%) | | |
| Polyvinyl pyrrolidone (trade name: PVP K-90, | 60 | parts by mass |
| manufactured by GAF Corporation) | | |
| Fluorine surfactant (trade name: SURFLON | 10 | parts by mass |
| S-131, manufactured by Asahi Glass Co., Ltd.) | | |
| Distilled water | 3350 | parts by mass |

Each of color pixel-forming coating solutions for red (R1), green (G1), and blue (B1) for a color filter was prepared in accordance with compositions shown in the following Table 2. These coating solutions were respectively coated on the supports, on each of which the thermoplastic resin layer and the intermediate layer has been provided thereon, by using a spin coater at 180 rpm, and the resultants were heated at 100° C. for 2 minutes in an oven for drying so as to provide photosensitive transfer materials for a color filter for red, green or blue.

TABLE 2

| | R1 | G1 | B1 |
|---|---|---|---|
| Benzylmethacrylate-methacrylic acid | 2.88 | 2.80 | 9.80 |
| copolymer (Molar ratio = 73:27; | | | |
| Molecular weight = 30,000) | | | |
| Dipentaerythritol hexaacrylate | 4.36 | 4.60 | 3.95 |
| Fluorine surfactant (trade name: MEGAFAC | 0.08 | 0.16 | 0.15 |
| F780, manufactured by Dainippon Ink and | | | |
| Chemicals Inc.,) | | | |
| 7-[2-[4-(3-hydroxymethylpiperidino)-6- | 0.44 | 0.16 | 0 |
| diethylamino] triasylamino]-3-phenyl | | | |
| 2-trichloromethyl-5-(p-styryl)-1,3, | 0.31 | 0.23 | 0.27 |
| 4-oxadiazol | | | |
| Phenothiazine | 0.013 | 0.006 | 0.030 |
| C.I. PR254 dispersant (trade name: RT-107, | 49.6 | 0 | 0 |
| manufactured by Fuji Film Olin Co., Ltd.) | | | |
| C.I. PV23 dispersant (trade name: MHI | 0.96 | 0 | 0 |
| VIOLET 7040M, manufactured by Mikuni | | | |
| Color) | | | |
| C.I. G36 dispersant (trade name: GT-2, | 0 | 22.0 | 0 |
| manufactured by Fuji Film Olin Co., Ltd.) | | | |
| C.I. PY138 dispersant (trade name: YT-128, | 0 | 11.4 | 0 |
| (manufactured by Fuji Film Olin Co., Ltd.) | | | |
| C.I. P815:6 dispersant (trade name: MHI | 0 | 0 | 27.7 |
| Blue 7045M, manufactured by Mikuni | | | |
| Color) | | | |
| Propyleneglycol monomethylether acetate | 1.3 | 11.9 | 6.3 |
| Methylethyl ketone | 38.3 | 37.7 | 50.6 |

*Concentration of pigment in dispersants in Table 2 are as follows.
RT-107: 8 wt %
MHI VIOLET 7040M: 8 wt %
YT-128: 13 wt %
MHI BLUE 7045M: 14 wt %
GT-2: 20.4 wt %

A color filter was prepared by the transfer method using each of the photosensitive transfer materials. Because a support having a conductive layer favorable in scratch resistance was used, the color filter showed no static adhesion and was favorable in handling and free from adsorption of dust. In addition, there was no clean room contamination, for example, by dust released from the conductive layer by friction during use for an extended period of time.

Thus, it was confirmed that the recording element (color filter) using the antistatic film according to the invention was effective in suppressing the deterioration of the cleanness of the environment or machines used due to dust derived from the conductive layer even during use for an extended period of time.

What is claimed is:

1. An antistatic film having a support and a conductive layer formed on at least one side of the support, wherein the conductive layer comprises:
a reaction product of:
a resin containing a plurality of carboxylic acid groups in the molecule and having a weight-average molecular weight of 2,000 or more with
a compound having a plurality of carbodiimide structures in the molecule; and
a conductive material which exhibits conductivity by electronic conduction.

2. An antistatic film according to claim 1, wherein the plurality of carboxylic acid groups includes carboxylic acid groups which are derived from at least one selected from the group consisting of acrylic acids and methacrylic acids.

3. An antistatic film according to claim 1, wherein the conductive material contains tin oxide.

4. An antistatic film according to claim 3, wherein the tin oxide has a needle-shaped structure having a ratio of the length of the shorter axis to the length of the longer axis in a range of 3 to 50.

5. An antistatic film according to claim 1, wherein the support is a polyester film.

6. An antistatic film according to claim 1, further comprising a protective layer having a thickness of 0.01 to 0.5 μm over the conductive layer.

7. A method of producing an antistatic film comprising:
preparing an aqueous coating solution; and
coating the aqueous coating solution on at least one side of a support,
wherein the aqueous coating solution comprises:
a resin containing a plurality of carboxylic acid groups in the molecule and having a weight-average molecular weight of 2,000 or more;
a compound having a plurality of carbodiimide structures in the molecule; and
a conductive material which exhibits conductivity by electronic conduction, and
wherein the sum of the solid matter concentration of the resin and the solid matter concentration of the compound is 10 wt % or less.

8. A method according to claim 7, wherein the plurality of carboxylic acid groups includes carboxylic acid groups which are derived from at least one selected from the group consisting of acrylic acids and methacrylic acids.

9. A method according to claim 7, wherein the conductive material contains tin oxide.

10. A method according to claim 9, wherein the tin oxide has a needle-shaped structure having a ratio of the length of the shorter axis to the length of the longer axis in a range of 3 to 50.

11. A method according to claim 7, wherein the support is a polyester film.

12. A method according to claim 7, further comprising providing a protective layer having a thickness of 0.01 to 0.5 μm over the conductive layer.

13. A recording element comprising an antistatic film and a recording layer which is photosensitive or heat-sensitive and is formed on one side of the antistatic film,
wherein the antistatic film has a support and a conductive layer formed on at least one side of the support, and the conductive layer comprises:
a reaction product of:
a resin containing a plurality of carboxylic acid groups in the molecule and having a weight-average molecular weight of 2,000 or more with
a compound having a plurality of carbodimide structures in the molecule; and
a conductive material which exhibits conductivity by electronic conduction.

14. A recording element according to claim 13, wherein the recording layer comprises an alkali-soluble binder and a polymerizable monomer and is capable of conducting polymerization by light or heat.

15. A recording element according to claim 13, wherein the plurality of carboxylic acid groups includes carboxylic acid groups which are derived from at least one selected from the group consisting of acrylic acids and methacrylic acids.

16. A recording element according to claim 13, wherein the conductive material contains tin oxide.

17. A recording element according to claim 16, wherein the tin oxide has a needle-shaped structure having a ratio of the length of the shorter axis to the length of the longer axis in a range of 3 to 50.

18. A recording element according to claim 13, wherein the support is a polyester film.

19. A recording element according to claim 13, further comprising a protective layer having a thickness of 0.01 to 0.5 μm over the conductive layer.

20. A recording element according to claim 13, further comprising a cushion layer and an intermediate layer provided between the support and the recording layer.
